(19) United States
(12) Patent Application Publication
(10) Pub. No.: US 2007/0157754 A1
(43) Pub. Date: Jul. 12, 2007

(54) Telescopic shaft for vehicle steering

(75) Inventor: Takatsugu Yamada, Gunma-ken (JP)

Correspondence Address: MILES & STOCKBRIDGE PC, 1751 PINNACLE DRIVE, SUITE 500, MCLEAN, VA, 22102-3833, US

(73) Assignee: NSK Ltd.

(21) Appl. No.: 10/587,402

(22) PCT Filed: Jan. 21, 2005
(86) PCT No.: PCT/JP05/01162

§ 371 Date: Jul. 26, 2006

(30) Foreign Application Priority Data
Jan. 27, 2004 (JP) 2004-019004

(51) Int. Cl. B62D 1/18

(52) U.S. Cl. 74/493

(57) ABSTRACT

A telescopic shaft for vehicle steering that is assembled into a steering shaft for a vehicle and has a female shaft and a male shaft that are fitted relatively unrotatably but slidably, the telescopic shaft for vehicle steering includes torque transmitting portions that are respectively disposed on an outer surface of the male shaft and on an inner surface of the female shaft and come in contact with each other for transmitting torque upon rotation, and a preload portion composed of a rolling member that is disposed between the outer surface of the male shaft and the inner surface of the female shaft at a different position from a position where the torque transmitting portions are located and rolls when the male shaft and the female shaft relatively move in the axial direction and an elastic member that is disposed adjacent to the rolling member in the diametral direction and gives pressure upon the male shaft and the female shaft through the rolling member, wherein when a gap in the torque transmitting portions is converted into a rotation angle A and a possible flexural amount of the elastic member in the preload portion is converted into a rotation angle B, the rotation angle A should be less than the rotation angle B upon transmitting no torque.

### TECHNICAL FIELD

The present invention relates to a telescopic shaft for vehicle steering.

### BACKGROUND ART

In a steering mechanism for a vehicle, in order to absorb axial displacement occurred upon traveling and to prevent the displacement and vibrations from being transferred onto a steering wheel, a telescopic shaft constructed by a male shaft and a female shaft that are spline-fitted to each other has been used in a portion of a steering mechanism. The telescopic shaft is required to be able to reduce backlash noises from the spline portion, backlash on the steering wheel, and sliding friction upon sliding in the axial direction.

In order to fill the requirements, the spline portion of a male shaft of a telescopic shaft is coated with nylon and a sliding portion thereof is applied by grease, thereby absorbing and reducing metallic noises, metallic knocking noises, and the like, as well as reducing sliding friction and backlash in the rotational direction. In this case, processes for forming a nylon layer are such that cleaning a shaft, applying primer thereon, heating it, coating nylon powder, cutting coarsely, cutting finely, and selectively fitting into a female shaft. The final cutting process is carried out by selecting a die corresponding to an already processed female shaft.

In Japanese Patent Application Laid-Open No. 2001-50293 (pages 7 and 13, FIG. 12), there is disclosed a telescopic shaft for vehicle steering in which balls are disposed in a groove formed on outer periphery of an inner shaft and inner periphery of an outer shaft with an elastic member disposed between the groove of the inner shaft and the balls, when moving along an axial direction, a sliding load between a male shaft and a female shaft is reduced by rotating the balls and when rotating, torque is transmitted by restraining the balls. The aforementioned document discloses that in order to make it possible to transmit torque even if the ball is broken, a male groove and a female groove each having a cross-sectional combination with a certain play are formed on the inner shaft and the outer shaft, respectively.

However, in the former case, it is necessary to suppress backlash of the telescopic shaft to be minimum with suppressing the sliding load to be minimum, so that in the final cutting process, a die corresponding to a female shaft has to be selected among dies each having different over-pin diameter with an interval of few micrometers resulting in increase in processing cost. In addition, backlash in the rotational direction becomes large as progress in wearing the nylon layer according to the used time length.

Moreover, with exposing to high temperature of the engine room, the nylon layer makes alteration in volume resulting in extreme increase in sliding friction and drastic acceleration of wear, so that backlash in the rotational direction becomes large. Accordingly, there has been a request to easily provide a telescopic shaft for vehicle steering capable of suppressing deterioration in steering feeling and generation of noises caused by backlash in the rotational direction for a long period with a low cost.

In the telescopic shaft for vehicle steering disclosed in Japanese Patent Application Laid-Open No. 2001-50293, which is the latter case, rotation of a plurality of balls provides telescopic movement and transmission of torque. Accordingly, since sufficient number of balls have to be disposed structurally to endure an input torque, there are structural defects such that it becomes difficult to be made compact as a telescopic shaft for vehicle steering, and it also becomes difficult to secure a sufficient collapse stroke upon collision.

### DISCLOSURE OF THE INVENTION

The present invention is made in view of aforementioned problems and has an object to provide a telescopic shaft for vehicle steering capable of realizing a stable sliding load, securely preventing backlash in the rotational direction, and transmitting torque under high rigidity.

In order to accomplish the object, the present invention provides a telescopic shaft for vehicle steering that is assembled into a steering shaft for a vehicle and has a female shaft and a male shaft that are fitted relatively unrotatably but slidably, the telescopic shaft for vehicle steering includes torque transmitting portions that are respectively disposed on an outer surface of the male shaft and on an inner surface of the female shaft and come in contact with each other for transmitting torque upon rotation, and a preload portion composed of a rolling member that is disposed between the outer surface of the male shaft and the inner surface of the female shaft at a different position from a position where the torque transmitting portions are located and rolls when the male shaft and the female shaft relatively move in the axial direction and an elastic member that is disposed adjacent to the rolling member in the diametral direction and gives pressure upon the male shaft and the female shaft through the rolling member, wherein when a gap in the torque transmitting portions is converted into a rotation angle A and a possible flexural amount of the elastic member in the preload portion is converted into a rotation angle B, the rotation angle A should be less than the rotation angle B upon transmitting no torque.

In the telescopic shaft for vehicle steering, it is preferable that the rotation angle A in the torque transmitting portions is set from 0.01 degrees to 0.25 degrees.

In the telescopic shaft for vehicle steering, it is preferable that the torque transmitting portions are composed of a projection elongated in the axial direction and having a substantially arc sectional shape formed on the outer surface of the male shaft and a groove elongated in the axial direction and having a substantially arc sectional shape formed on the inner surface of the female shaft.

In the telescopic shaft for vehicle steering, it is preferable that the torque transmitting portions do not come in contact with each other continuously in the axial direction upon transmitting no torque.

In the telescopic shaft for vehicle steering, it is preferable that the torque transmitting portions are composed of a spline-fitting structure or a serration-fitting structure formed on the outer surface of the male shaft and the inner surface of the female shaft.

In the telescopic shaft for vehicle steering, it is preferable that the preload portion has a first axial groove disposed on the outer surface of the male shaft and a second axial groove disposed on the inner surface of the female shaft opposite to the first axial groove, and the rolling member and the elastic member are disposed between the first axial groove and the second axial groove.

In the telescopic shaft for vehicle steering, it is preferable that a plurality of preload portions are disposed between the male shaft and the female shaft, and a plurality of transmitting portions are disposed between adjacent preload portions.

In the telescopic shaft for vehicle steering, it is preferable that the preload portions are disposed in the circumferential direction with an interval of 180 degrees having the torque transmitting portions in-between.

In the telescopic shaft for vehicle steering, it is preferable that the preload portions are disposed in the circumferential direction with an interval of 120 degrees having the torque transmitting portions in-between.

In the telescopic shaft for vehicle steering, it is preferable that the torque transmitting portions are disposed at the center in the circumferential direction between the preload portions.

In the telescopic shaft for vehicle steering, the rolling member may include at least one spherical body.

In the telescopic shaft for vehicle steering, it is preferable that the elastic member is composed of a leaf spring.

In the telescopic shaft for vehicle steering, it is preferable that a solid lubricant film is formed on the outer surface of the male shaft or the inner surface of the female shaft.

As described above, according to the present invention, when a gap in the torque transmitting portions is converted into a rotation angle A and a possible flexural amount of the elastic member in the preload portion is converted into a rotation angle B, the rotation angle A is set to be less than the rotation angle B upon transmitting no torque. Accordingly, when high torque is transmitted, the torque transmitting portions transmitting primary torque can come into contact with each other securely earlier than the preload portion transmitting lower torque to remove backlash. As a result, it becomes possible to prevent an excessive load from applying on the preload portion, so that backlash in the rotational direction can be prevented and torque can be transmitted with high rigidity over an extended time period.

### BRIEF DESCRIPTION OF THE DRAWINGS

FIG. 1 is a side view showing a steering mechanism of a vehicle applied a telescopic shaft for vehicle steering according to an embodiment of the present invention.

FIG. 2 is a vertical cross-sectional view showing a telescopic shaft for vehicle steering according to a first embodiment of the present invention.

FIG. 3 is a partial sectional view along a III-III line in FIG. 2.

FIG. 4 is a graph showing a relation between torque and a rotation angle of the telescopic shaft for vehicle steering according to the first embodiment of the present invention.

FIG. 5A is a cross-sectional view showing a telescopic shaft for vehicle steering according to a first variation of the first embodiment of the present invention. FIG. 5B is a cross-sectional view showing a telescopic shaft for vehicle steering according to a second variation of the first embodiment of the present invention.

FIG. 6A is a cross-sectional view showing a telescopic shaft for vehicle steering according to a third variation of the first embodiment of the present invention. FIG. 6B is a cross-sectional view showing a telescopic shaft for vehicle steering according to a fourth variation of the first embodiment of the present invention.

FIG. 7A is a cross-sectional view showing a telescopic shaft for vehicle steering according to a fifth variation of the first embodiment of the present invention. FIG. 7B is a cross-sectional view showing a telescopic shaft for vehicle steering according to a sixth variation of the first embodiment of the present invention.

FIG. 8 is a cross-sectional view showing a telescopic shaft for vehicle steering according to a seventh variation of the first embodiment of the present invention.

FIG. 9 is a cross-sectional view showing a telescopic shaft for vehicle steering according to a second embodiment of the present invention.

FIG. 10 is a cross-sectional view showing a telescopic shaft for vehicle steering according to a first variation of the second embodiment of the present invention.

FIG. 11 is a cross-sectional view showing a telescopic shaft for vehicle steering according to a second variation of the second embodiment of the present invention.

FIG. 12A is a vertical cross-sectional view showing a telescopic shaft for vehicle steering according to a third variation of the second embodiment of the present invention. FIG. 12B is a cross-sectional view along a b-b line in FIG. 12A.

### BEST MODE FOR CARRYING OUT THE INVENTION

A telescopic shaft for vehicle steering according to an embodiment of the present invention will be described below with reference to the accompanying drawings.

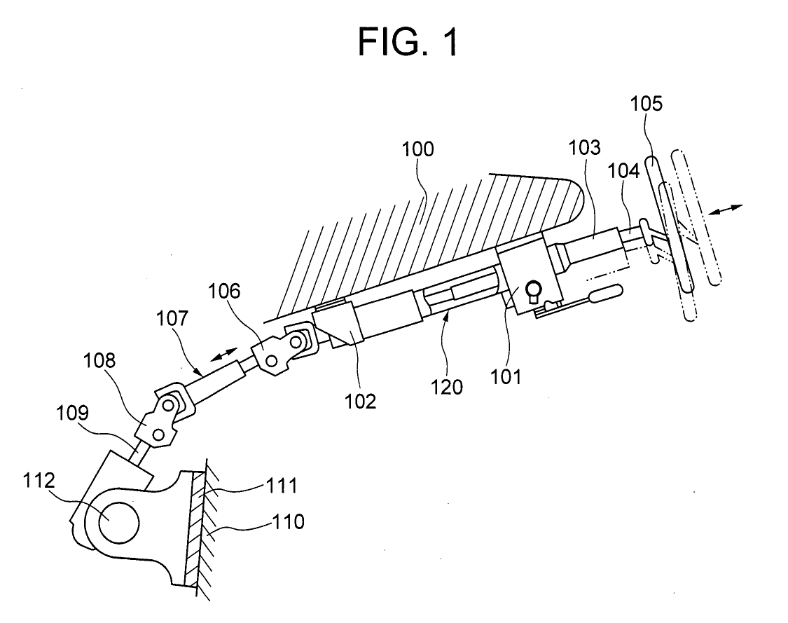

FIG. 1 is a side view showing a steering mechanism of a vehicle applied a telescopic shaft for vehicle steering according to an embodiment of the present invention.

In FIG. 1, a steering apparatus is composed of an upper steering shaft 120 (including a steering column 103, and a steering shaft 104 rotatably supported by the steering column 103) fixed to a solid member 100 of a vehicle through an upper bracket 101 and a lower bracket 102, a steering wheel 105 fixed to an upper end of the steering shaft 104, a lower steering shaft 107 connected to a lower end of the steering shaft 104 through a universal joint 106, a pinion shaft 109 connected to the lower steering shaft 107 through a steering shaft joint 108, and a steering rack 112 connected to the pinion shaft 109 and fixed to another frame 110 of the vehicle through an elastic member 111.

In this construction, a telescopic shaft for vehicle steering (hereinafter shown as a telescopic shaft) according an embodiment of the present invention is used in the upper steering shaft 120 and the lower steering shaft 107. The lower steering shaft 107 is constructed by fitting a male shaft and a female shaft with each other. Such lower steering shaft 107 is required to have a function absorbing axial displacement generated upon driving a vehicle and not transmitting the displacement or vibrations to the steering wheel 105. Such function is required when the body has a sub-frame structure, and the solid member 100 on which the upper portion of the steering apparatus is fixed and the frame 110 on which the steering rack 112 is fixed are separate structures and press-fitted each other through an elastic member 111 such as rubber. Moreover, there is a case where the telescopic function is required such as when the steering shaft joint 108 is fixed to the pinion shaft 109, the telescopic shaft is temporarily retracted in order to fit in and fix the pinion shaft 109. Furthermore, the upper steering shaft 120 is constructed by fitting a male shaft and a female shaft with each other. Such upper steering shaft 120 is required to have a telescopic function that in order for a driver to obtain an optimum driving position, the portion of the steering wheel 105 can be moved in the axial direction to be adjusted the position. In all cases described above, the telescopic shaft is required to have a function to reduce backlash noises generated from a fitting portion, backlash on the steering wheel 105 and sliding friction upon sliding in the axial direction.

### First Embodiment

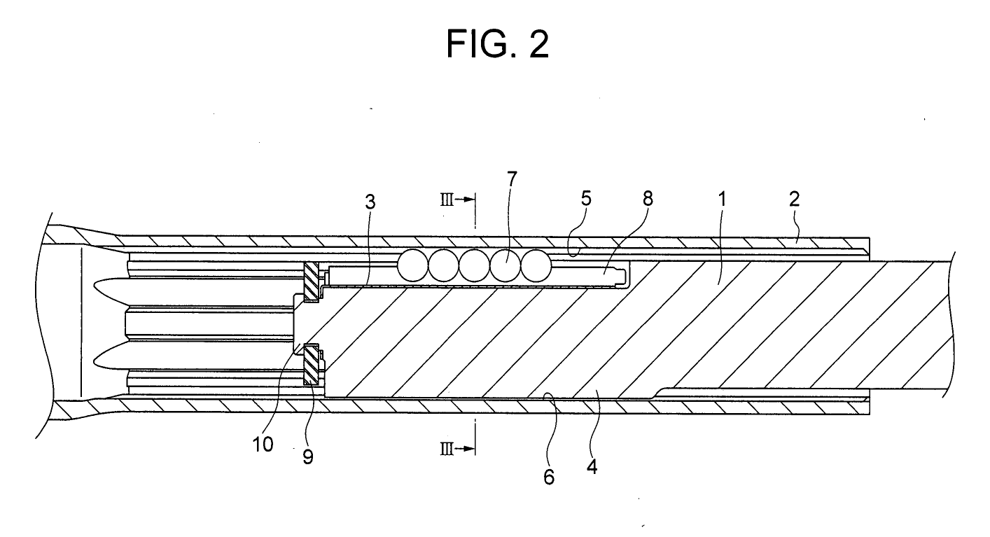

FIG. 2 is a vertical cross-sectional view showing a telescopic shaft for vehicle steering according to a first embodiment of the present invention.

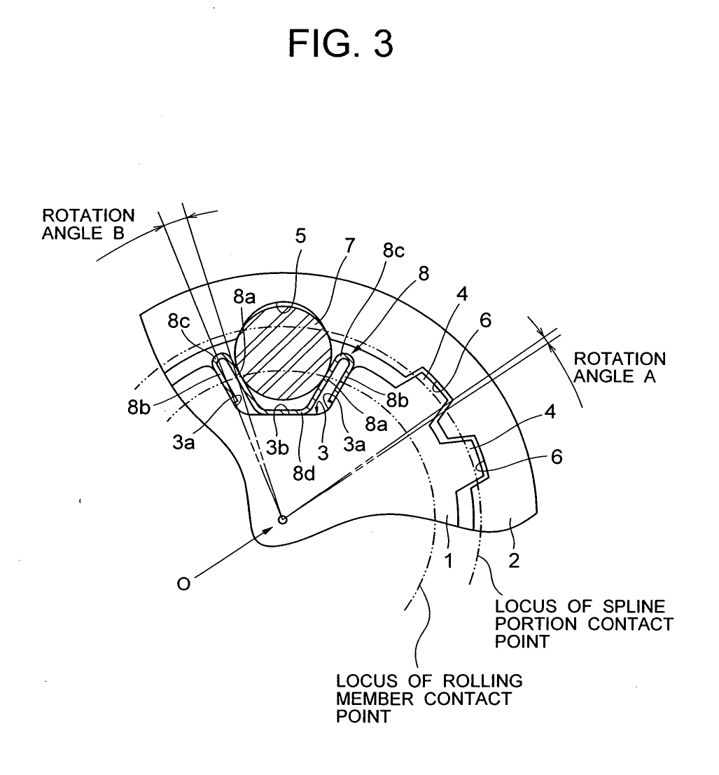

FIG. 3 is a partial sectional view along a III-III line in FIG. 2.

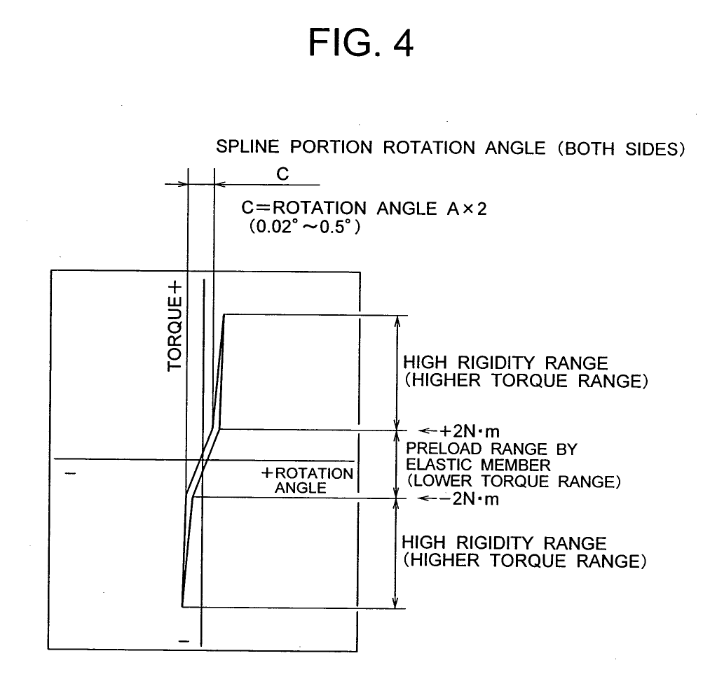

FIG. 4 is a graph showing a relation between torque and a rotation angle of the telescopic shaft for vehicle steering according to the first embodiment of the present invention.

As shown in FIGS. 2 and 3, a telescopic shaft for vehicle steering (hereinafter called a telescopic shaft) is composed of a male shaft 1 and a female shaft 2 disposed concentrically around the center 0 and fitted unrotatably but slidably with each other.

In the first embodiment, although only a portion is shown in FIG. 3, a plurality of elongated projections 4 extending in the axial direction are formed on the outer surface of the male shaft 1. Although each of the axially elongated projections 4 is a male portion of a spline fitting, it may be a male portion of a serration fitting or simply a portion for a protuberance-concavity fitting.

On the inner surface of the female shaft 2 at respective positions opposite to respective projections 4 on the male shaft 1, there are formed a plurality of grooves 6 extending in the axial direction. Although each of these axial grooves 6 is a female portion of a spline fitting, it may be a female portion of a serration fitting or simply a portion for a protuberance-concavity fitting.

Although only a portion is shown in FIG. 3, a plurality of grooves 3 extending in the axial direction are formed on the outer surface of the male shaft 1. On the inner surface of the female shaft 2 at respective positions opposite to them, a plurality of grooves 5 extending in the axial direction are formed. The axial grooves 3 and the axial grooves 5 are preferably disposed at regular intervals in the circumferential direction. Between the axial groove 3 on the male shaft 1 and the axial groove 5 on the female shaft 2, there are rotatably disposed a plurality of rolling members 7 which are rigid bodies and rotate upon relatively sliding the shafts 1 and 2 in the axial direction. The axial groove 5 on the female shaft 2 takes a substantially arc shape or a Gothic arch shape in section.

The axial groove 3 on the male shaft 1 is composed of a pair of slanted planer sides 3a and 3a, and a bottom 3b formed planer between the planer sides 3a and 3a.

Between the axial groove 3 on the male shaft 1 and the rolling member 7, there is disposed an elastic member 8 which is in contact with the rolling member 7 to apply a preload.

The elastic member 8 has rolling member contact portions 8a and 8a for coming in contact with the rolling member 7 at two points, groove side contact portions 8b and 8b that are separated from the rolling member contact points 8a and 8a with given intervals in the circumferential direction respectively and come in contact with the respective planer sides 3a and 3a of the axial groove 3 on the male shaft 1, spring portions 8c and 8c that elastically apply pressure to respective rolling member contact portions 8a and 8a and respective groove side contact portions 8b and 8b in a direction separating from each other, and a bottom portion 8d that is opposite to the bottom 3b of the axial groove 3.

Each spring portion 8c has a substantially U-shape with a bending portion having a substantially arc shape. The spring portion 8c having such a bending shape makes it possible to elastically apply pressure to separate the rolling member contact portion 8a from the groove side contact portion 8b. In this manner, the elastic member 8 elastically holds the rolling member 7 substantially equally from both sides.

On an end of the male shaft 1 where the male shaft 1 is inserted into the female shaft 2, a stopper plate 9 for stopping and fixing the elastic member 8 in the axial direction is fixed to the male shaft 1 by plastically deforming a clinching or caulking portion 10. The stopper plate 9 also plays a roll to prevent the rolling member 7 from coming off from the axial groove 3 of the male shaft 1. In this manner, the telescopic shaft for vehicle steering according to the embodiment is constructed.

In the telescopic shaft described above, upon rotation, in other words, upon transmitting higher torque the axially elongated projection 4 and the axial groove 6 come in contact with each other to form torque transmitting portions, while the axially elongated projection 4 and the axial groove 6 are constructed not to come in contact with each other upon transmitting no torque as described later.

Since the telescopic shaft according to the embodiment of the present invention is constructed as described above, the male shaft 1 and the female shaft 2 are in contact with each other at torque transmitting portions by the existence of preload always slidably, so that upon moving relatively in the axial direction the male shaft 1 and the female shaft 2 slide with each other and the rolling member 7 can be rotated.

Even if the axially elongated projection 4 formed on the male shaft 1 is formed on the female shaft 2 and the axial groove 6 formed on the female shaft 2 is formed on the male shaft 1, the similar action and effect as the present embodiment can be obtained. It may be possible that the curvature of the axial groove 5 is made to be different from that of the rolling member 7 to come into point contact with each other. Moreover, the elastic member 8 may be a leaf spring. Furthermore, by applying grease on the sliding surface and rolling surface, a further lower sliding load can be obtained.

The telescopic shaft according the present embodiment as described above is superior to the conventional one in the aspects described below.

When the sliding surface is purely effected by sliding as in a prior art, a preload for preventing backlash has had to be kept within a certain extent. A sliding load is derived from a friction coefficient multiplied by a preload. Accordingly, when a preload is increased in hope of preventing backlash and increasing stiffness of the telescopic shaft, it causes a vicious circle of increasing the sliding load.

In that respect according to the present embodiment, since a preload portion adopts a rolling mechanism of the rolling members 7 upon relative movement in the axial direction, a preload can be increased without excessively increasing sliding load. Accordingly, preventing backlash and increasing stiffness can be accomplished without increasing a sliding load, which has never been accomplished by any prior arts.

Upon transmitting high torque, the axially elongated projection 4 and the axial grooves 6 at the torque transmitting portions come in contact with each other to play the roll of torque transmission, while in the preload portion the elastic member 8 is elastically deformed to restrict the rolling member 7 between the male shaft 1 and the female shaft 2 in the circumferential direction resulting in preventing backlash and transmitting low torque.

For example, when torque is input from the male shaft 1, in early stage since a preload of the elastic member 8 is applied, backlash is prevented.

Upon further increasing the torque, the axially elongated projection 4 and a side of the axial groove 6 at the torque transmitting portions firmly come in contact with each other, the axially elongated projection 4 receives stronger reactive force than the rolling member 7, and the torque transmitting portions composed of the axially elongated projection 4 and the axial groove 6 mainly transmit torque. Accordingly, in the present embodiment, backlash between the male shaft 1 and the female shaft 2 in the circumferential direction is securely prevented and torque can be transmitted in a high rigitity state.

In the telescopic shaft according to the present embodiment having above-described construction as shown in FIG. 3, when a gap between a side of the axially elongated projection 4 and an opposing side of the axial groove 6 in the torque transmitting portions is converted into a rotation angle A, and a possible flexural amount of the elastic member 8 in the preload portion is converted into a rotation angle B, the rotation angle A is set to be less than the rotation angle B upon transmitting no torque.

Moreover, the rotation angle A at the torque transmitting portions is preferably set from 0.01 degrees to 0.25 degrees.

With constructing in this manner, upon transmitting torque, the axially elongated projection 4 and the axial groove 6 composing the torque transmitting portions can become in contact with each other securely earlier than the rolling member 7 and the elastic member 8 which compose the preload portion. Accordingly, it becomes possible to prevent excessive load from applying to the rolling member 7 and the elastic member 8 in the preload portion.

It is preferable that the axially elongated projection 4 and the axial groove 6, which are the torque transmitting portions spline-fitted each other, basically do not come in contact with each other upon transmitting no torque.

Then, the rotation angle A at the torque transmitting portions is explained with reference to FIG. 4. As described above, the rotation angle A is preferably set from 0.01 degrees to 0.25 degrees.

As a reason of the lower limit, an interval between the axially elongated projection 4 and the axial groove 6 which compose the torque transmitting portions is necessary to have a gap capable of allowing them to slide with each other without resistance. A gap having 2 μm or more is sufficient. The amount is converted into the rotation angle of 0.01 degrees.

As a reason of the upper limit, when an interval between the axially elongated projection 4 and the axial groove 6 which compose the torque transmitting portions is set excessively large, the rotation angle C in FIG. 4 becomes too large. As a result, the preload range by the elastic member 8 becomes large, so that it becomes impossible to obtain a good steering feeling with high degree of rigidity. In this situation, as a result of evaluating various trial models, the upper limit of the rotation angle A of the projection 4 is set to 0.25 degrees.

It is preferable that a point of inflection from the preload range by the elastic member 8 (lower torque range) to the high rigidity range (higher torque range) is +2N·m or more, or −2N·m or less. Incidentally, this is derived from in-vehicle sensory test result.

In addition to the above-described explanation, each component of the telescopic shaft according to the present embodiment is preferably constructed as shown in Tables 1 and 2 shown blow.

TABLE 1

| PARTS | ITEM | CONTENTS |
|---|---|---|
| male | material | C: 0.3% or more. |
| shaft (1) | | Mn: 0.3% or more |
| | hardness | HV120 or more |
| | roughness, | solid lubricant film (MOS2, |
| | surface treatment | PTFE, or the like) |
| | groove shape, | cold forming |
| | processing | broaching |
| | shaft diameter | 13 mm or more |
| | structure, shape | spline module 0.4˜3 |
| female | material | C: 0.2% or more |
| shaft (2) | hardness | HV120 or more |
| | roughness, surface | solid lubricant film (MOS2, |
| | treatment | PTFE, or the like) |
| | groove shape, | cold forming |
| | processing | broaching |
| | structure, shape | spline module 0.4˜3 |
| | | ball groove: 2˜6 rows |
| elastic | material | SK |
| member | | S50C˜60C |
| (8) | | SUS304 |
| | hardness | HV300˜400 |
| | heat treatment | quenching, tempering |
| | structure, shape | plate thickness: 0.1˜1 mm |
| | processing | press forming |

TABLE 2

| PARTS | ITEM | CONTENTS |
|---|---|---|
| rolling | material | SUJ2, ceramic, or the like |
| member | hardness | HV300 or more |
| (7) | structure, | 3˜10 pieces/row |
| | shape | diameter: 3˜7 mm |
| retainer | material | resin |
| | | steel |
| | structure, shape | integrated |
| stopper | processing | press |
| plate (9) | structure, shape | caulking(or clinching) |
| grease | material | with solid lubricant |
| | | (MOS2, PTFE, or the like) |

Since the axially elongated projection 4 and the axial groove 6 receive load with continuously coming in contact with each other in the axial direction upon transmitting torque, various merits can be expected such as the contact pressure can be suppressed lower than that in the rolling member 7 which receives load with point contact. Accordingly, the present embodiment is superior to the conventional one which uses ball rolling mechanism in all rows in the following items:

Attenuation effect in the sliding portion is larger than that in the ball rolling mechanism. Accordingly, vibration absorption effect is high.

Since the contact pressure can be lower in the axially elongated projection 4 upon transmitting the same torque, the axial length of the torque transmitting portions can be smaller, so that the space can be used effectively.

Since the contact pressure can lower in the axially elongated projection 4 upon transmitting the same torque, it is not necessary to carry out additional processing for hardening the surface of the axial groove of the female shaft such as thermal treatment and the like.

The number of parts can be small.

Assembling can be easy.

Assembling cost can be lowered.

Since torque transmission is mainly carried out by the torque transmitting portions, the number of the rolling member 7 can be small, and a collapse stroke can be made large.

Moreover, in respect of partially applying the rolling member 7, the present embodiment is superior in the following items to the conventional one that all rows are spline-fitted and all rows are slid:

Since friction force is low, a sliding load can be suppressed.

Since preload can be high, backlash can be prevented for long period and high rigidity can be obtained.

### Variations of the First Embodiment

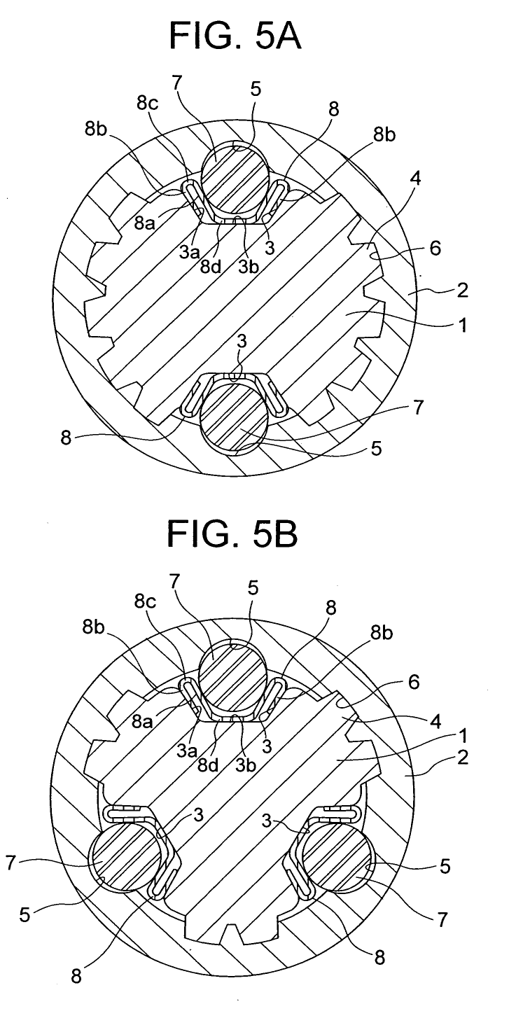

FIG. 5A is a cross-sectional view showing a telescopic shaft for vehicle steering according to a first variation of the first embodiment of the present invention. FIG. 5B is a cross-sectional view showing a telescopic shaft for vehicle steering according to a second variation of the first embodiment of the present invention.

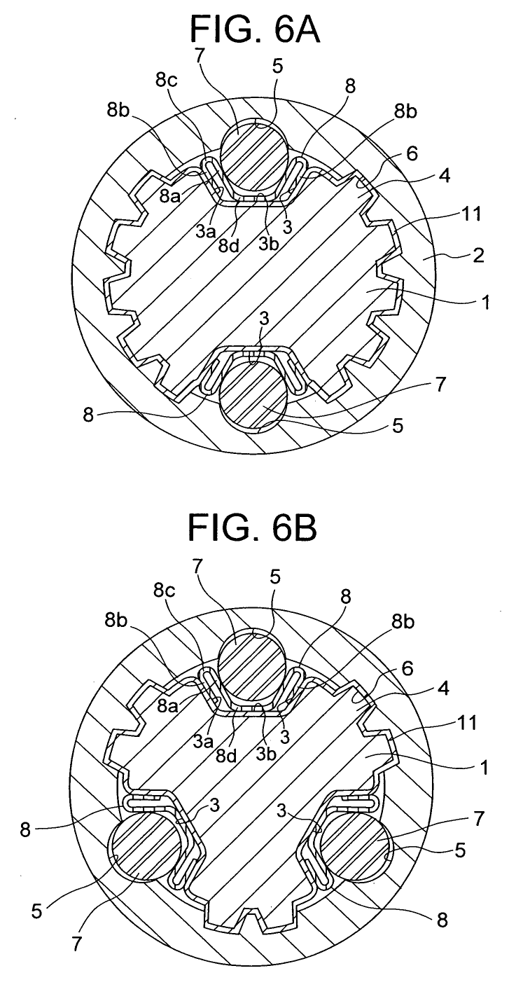

FIG. 6A is a cross-sectional view showing a telescopic shaft for vehicle steering according to a third variation of the first embodiment of the present invention. FIG. 6B is a cross-sectional view showing a telescopic shaft for vehicle steering according to a fourth variation of the first embodiment of the present invention.

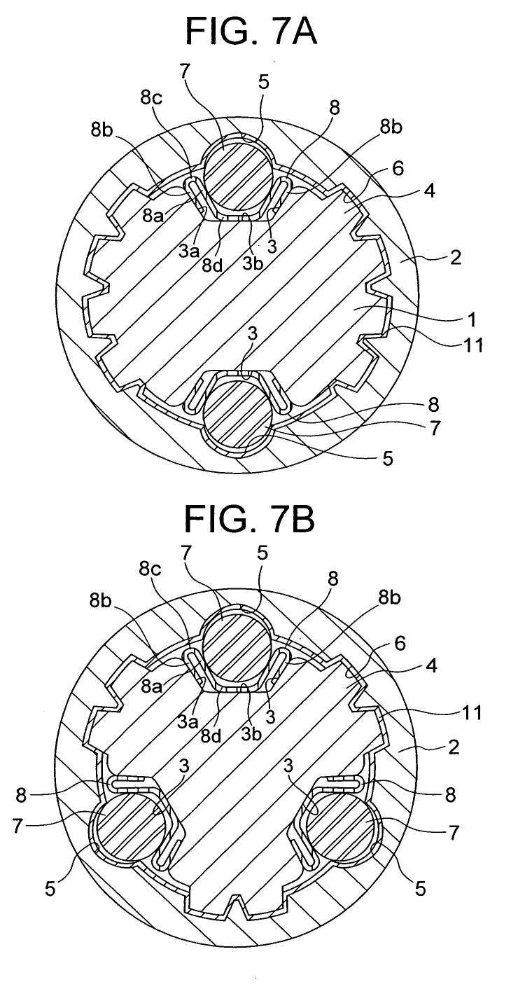

FIG. 7A is a cross-sectional view showing a telescopic shaft for vehicle steering according to a fifth variation of the first embodiment of the present invention. FIG. 7B is a cross-sectional view showing a telescopic shaft for vehicle steering according to a sixth variation of the first embodiment of the present invention.

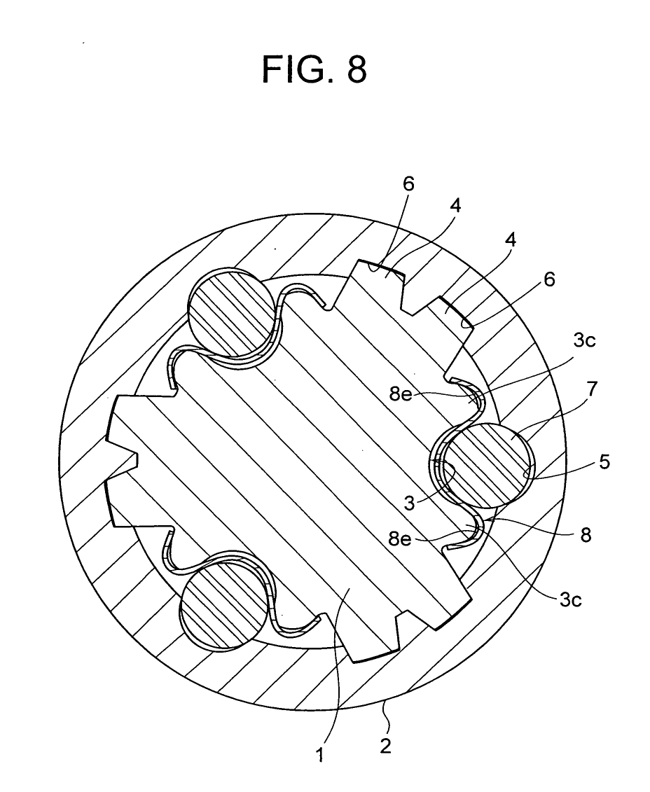

FIG. 8 is a cross-sectional view showing a telescopic shaft for vehicle steering according to a seventh variation of the first embodiment of the present invention.

In all of the following variations, each of the similar construction to the first embodiment is attached to the same reference number, and the explanation thereof is omitted.

In a telescopic shaft for vehicle steering composed of a male shaft 1 and a female shaft 2, which are spline fitted each other, according to the first variation shown in FIG. 5A, similar preload portions as the first embodiment are disposed between the male shaft 1 and the female shaft 2 with 180 degrees intervals in the circumferential direction. A plurality of torque transmitting portions (axially elongated projections 4 and axial grooves 6) each of which is spline fitted as same as the first embodiment are disposed in each interval between the preload portions. The other configurations, actions and effects are the same as those of the first embodiment, and the explanations are omitted.

In a telescopic shaft for vehicle steering composed of a male shaft 1 and a female shaft 2, which are spline fitted each other, according to a second variation shown in FIG. 5B, similar preload portions as the first embodiment are disposed between the male shaft 1 and the female shaft 2 with an 120 degrees interval in the circumferential direction. A plurality of torque transmitting portions (axially elongated projections 4 and axial grooves 6) each of which is spline fitted as same as the first embodiment are disposed in each interval between the preload portions. By disposing the preload portions with a 120 degrees interval in the circumferential direction, decentering of the shaft can be improved relative to the first variation, so that right and left difference in torsional rigidity upon loading high torque as well as right and left difference in a total sliding load upon loading high torque can be reduced. The other configurations, actions and effects are the same as those of the first embodiment, and the explanations are omitted.

A third variation shown in FIG. 6A and a fourth variation shown in FIG. 6B have a characteristic feature of forming a solid lubricant film 11 on the outer surface of the male shaft 1 relative to the first variation shown in FIG. 5A and the second variation shown in FIG. 5B. In this manner, by forming a solid lubricant film 11 on the outer surface of the male shaft 1, contact resistance between the axially elongated projection 4 and the axial groove 6 in the torque transmitting portions can be lowered, so that the total sliding load (which is a sliding load generated in ordinary use in the construction according to the present invention in which both rolling and sliding are acting) can be lowered in comparison with the first and second variations. As for a solid lubricant film, there are used films formed such that molybdenum disulfide powder is dispersively mixed in resin, the mixture is applied by spray coating or dip coating, and baked to form the film, or PTFE (polytetrafluoroethylene) is dispersively mixed in resin, the mixture is applied by spray coating or dip coating, and baked to form the film. Alternatively, instead of the solid lubricant film, resin may be coated.

A fifth variation shown in FIG. 7A and a sixth variation shown in FIG. 7B have a characteristic feature of forming a solid lubricant film 11 on the inner surface of the female shaft 2 relative to the first variation shown in FIG. 5A and the second variation shown in FIG. 5B. In this manner, by forming a solid lubricant film 11 on the inner surface of the female shaft 2, contact resistance between the axially elongated projection 4 and the axial groove 6 at the torque transmitting portions can be lowered, so that the total sliding load (which is a sliding load generated in ordinary use in the construction according to the present invention in which both rolling and sliding are acting) can be lowered in comparison with the first and second variations. As for a solid lubricant film, there are used films formed such that molybdenum disulfide powder is dispersively mixed in resin, the mixture is applied by spray coating or dip coating, and baked to form the film, or PTFE (polytetrafluoroethylene) is dispersively mixed in resin, the mixture is applied by spray coating or dip coating, and baked to form the film.

In a seventh variation shown in FIG. 8, a shape of an elastic member at a preload portion is different from that in the first embodiment. In particular, the shape of an elastic member at the preload portion is different from that in the first variation shown in FIG. 5B. The other configurations, actions and effects are the same as those of the first embodiment. Upon transmitting no torque, the elastic member 8 preloads the rolling member 7 against the female shaft 2 to the extent of having no backlash, and upon transmitting torque, the elastic member 8 elastically deforms to restrict the rolling member 7 in the circumferential direction between the male shaft 1 and the female shaft 2. The elastic member 8 is fixed to ridges 3c disposed both sides of the axial groove 3 on the male shaft 1 by means of groove portions 8e disposed both ends thereof. With this configuration, the elastic member 8 cannot be moved in the circumferential direction upon transmitting torque.

In the aforementioned first through seventh variations, a further lower sliding load can be obtained by applying grease on the sliding surface and rolling surface. When the axially elongated projection 4 formed on the male shaft is formed on the female shaft, or the axial groove 6 formed on the female shaft is formed on the male shaft, the similar action and effect as the present embodiment can be obtained. The curvature of the axial groove 5 and that of the rolling member 7 may be different from to come into point contact with each other.

### Second Embodiment

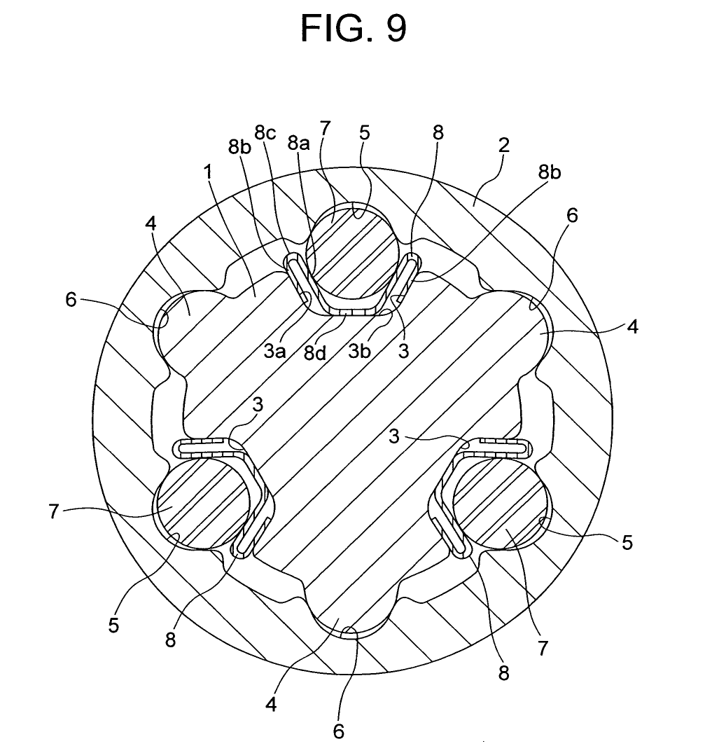

FIG. 9 is a cross-sectional view showing a telescopic shaft for vehicle steering according to a second embodiment of the present invention.

In the second embodiment, each of the similar construction to the first embodiment is attached to the same reference number, and the explanation is omitted.

In the second embodiment, three axially elongated projections 4 each having a substantially arc sectional shape are formed in the axial direction on the outer surface of the male shaft 1 with an equal interval of 120 degrees in the circumferential direction. Three axial grooves 6 each having a substantially arc sectional shape are formed in the axial direction on the inner surface of the female shaft 2 at the portions opposite to the three axially elongated projections 4 on the male shaft.

The axially elongated projection 4 and the axial groove 6 basically do not come in contact with each other upon transmitting no torque, however, come in contact with each other forming torque transmitting portions upon transmitting high torque.

The axially elongated projection 4 and the axial groove 6 have a substantially arc shape or a Gothic arch shape in section, however, other shapes may be applicable.

In the present embodiment also, when a gap between the axially elongated projection 4 and the axial groove 6 in the torque transmitting portions is converted into a rotation angle A, and a possible flexural amount of the elastic member 8 in the preload portion is converted into a rotation angle B, the rotation angle A is set to be less than the rotation angle B upon transmitting no torque.

Moreover, the rotation angle A in the torque transmitting portions is preferably set from 0.01 degrees to 0.25 degrees.

With constructing in this manner, upon transmitting torque, the torque transmitting portions (composed of the axially elongated projection 4 and the axial groove 6) can prevent backlash and come in contact with each other securely earlier than the preload portion (composed of the rolling member 7 and the elastic member 8) which transmits lower torque. Accordingly, it becomes possible to prevent excessive load from applying to the preload portion (the rolling member 7 and the elastic member 8). It is preferable that the torque transmitting portions (the axially elongated projection 4 and the axial groove 6), which are spline-fitted each other, basically do not come in contact with each other upon transmitting no torque.

### Variations in Second Embodiment

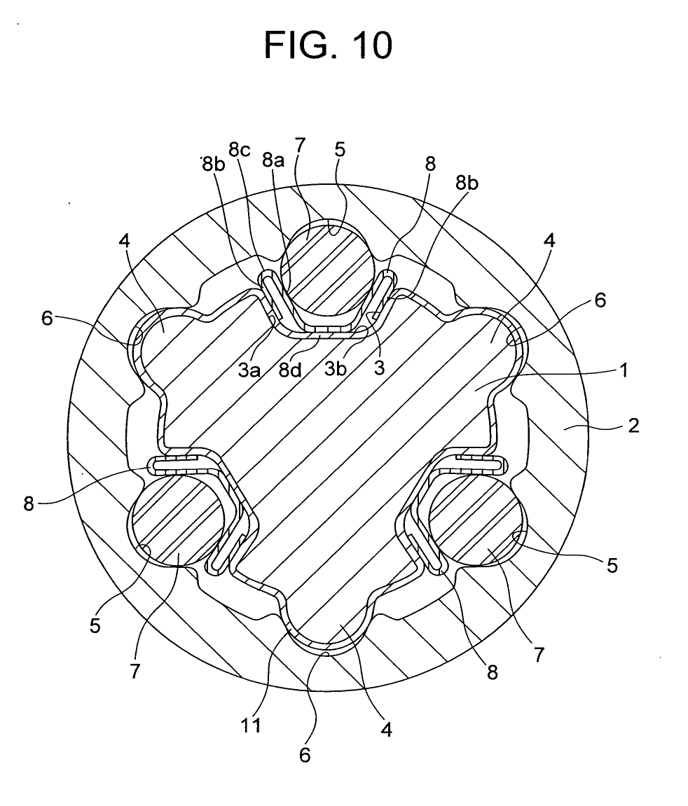

FIG. 10 is a cross-sectional view showing a telescopic shaft for vehicle steering according to a first variation of the second embodiment of the present invention.

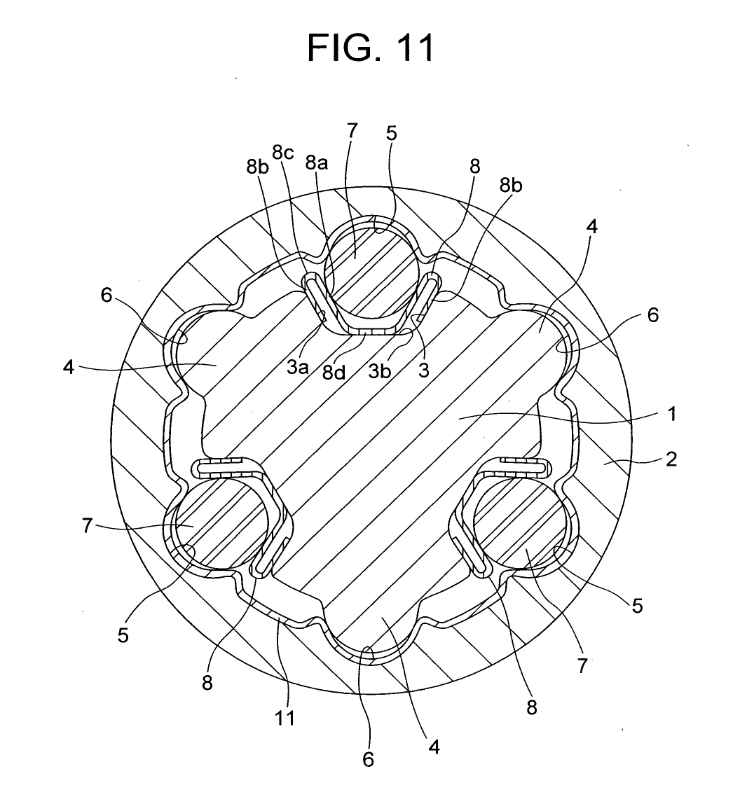

FIG. 11 is a cross-sectional view showing a telescopic shaft for vehicle steering according to a second variation of the second embodiment of the present invention.

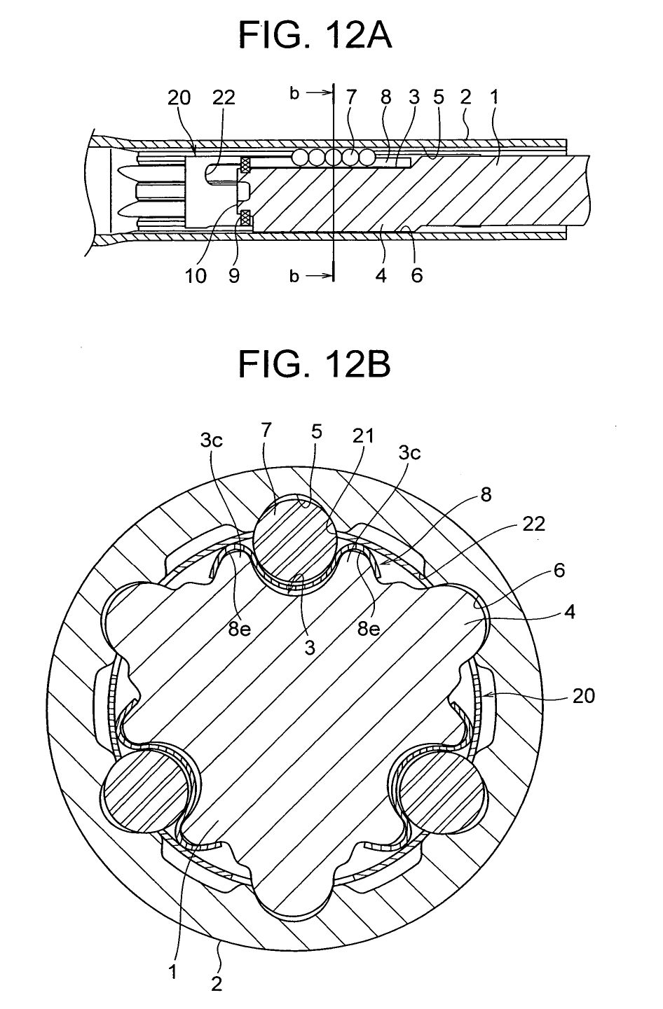

FIG. 12A is a vertical cross-sectional view showing a telescopic shaft for vehicle steering according to a third variation of the second embodiment of the present invention. FIG. 12B is a cross-sectional view along a b-b line in FIG. 12A.

In all of the following variations, each of the similar constructions to the first or second embodiment is attached to the same reference number, and the explanation thereof is omitted.

The first variation shown in FIG. 10 has a characteristic feature of forming a solid lubricant film 11 on the outer surface of the male shaft 1 relative to the second embodiment. In this manner, by forming a solid lubricant film 11 on the outer surface of the male shaft 1, contact resistance between the axially elongated projection 4 and the axial groove 6 in the torque transmitting portions can be lowered, so that the total sliding load (which is a sliding load generated in ordinary use in the construction according to the present invention in which both rolling and sliding are acting) can be lowered in comparison with the first embodiment. As for a solid lubricant film 11, there are used films formed such that molybdenum disulfide powder is dispersively mixed in resin, the mixture is applied by spray coating or dip coating, and baked to form the film, or PTFE (polytetrafluoroethylene) is dispersively mixed in resin, the mixture is applied by spray coating or dip coating, and baked to form the film. Alternatively, instead of the solid lubricant film, resin may be coated. Although the solid lubricant film 11 is formed over entire outer surface of the male shaft 1, it may be formed only on the outer surface of the axially elongated projections 4 disposed at three positions on the male shaft 1. This is because the primary factor of the sliding load upon transmitting high torque is contact between the axially elongated projection 4 and the axial groove 6, so that the axial sliding resistance can be lowered by lowering the contact resistance in the contact position.

The second variation shown in FIG. 11 has a characteristic feature of forming a solid lubricant film 11 on the inner surface of the female shaft 2 relative to the second embodiment. In this manner, by forming a solid lubricant film 11 on the inner surface of the female shaft 2, contact resistance between the axially elongated projection 4 and the axial groove 6 in the torque transmitting portions can be lowered, so that the total sliding load (which is a sliding load generated in ordinary use in the construction according to the present invention in which both rolling and sliding are acting) can be lowered in comparison with the first embodiment. As for a solid lubricant film 11, there are used films formed such that molybdenum disulfide powder is dispersively mixed in resin, the mixture is applied by spray coating or dip coating, and baked to form the film, or PTFE (polytetrafluoroethylene) is dispersively mixed in resin, the mixture is applied by spray coating or dip coating, and baked to form the film. Although the solid lubricant film 11 is formed over entire inner surface of the female shaft 2, it may be formed only on the inner surface of the axial grooves 6 disposed at three positions on the female shaft 2. This is because the primary factor of the sliding load upon transmitting high torque is contact between the axially elongated projection 4 and the axial groove 6, so that the axial sliding resistance can be lowered by lowering the contact resistance in the contact portion.

In a third variation shown in FIG. 12, a shape of an elastic member in a preload portion is different from that in the above-described second embodiment. Upon transmitting no torque, the elastic member 8 preloads the rolling member 7 against the female shaft 2 to the extent of having no backlash, and upon transmitting torque, the elastic member 8 elastically deforms to restrict the rolling member 7 in the circumferential direction between the male shaft 1 and the female shaft 2. The elastic member 8 is fixed to ridges 3c disposed both sides of the axial groove 3 on the male shaft 1 by means of groove portions 8e disposed both ends thereof. With this configuration, the elastic member 8 cannot be moved in the circumferential direction upon transmitting torque. In a third variation shown in FIG. 12, a retainer 20 for rotatably retaining the rolling member 7 without interfering the axially elongated projection 4 is disposed between the male shaft 1 and the female shaft 2. The other configurations are the same as the above-described second embodiment. The retainer 20 has a cylindrical shape disposed with an elongate hole 21 for rotatably holding the rolling member 7 and an interference avoiding elongate hole 22 that is disposed at a position opposite to the axially elongated projection 4 and avoids interference with the axially elongated projection 4. The interference avoiding elongate hole 22 is formed conspicuously longer than the elongate hole 21 in the axial direction. With this configuration, although both of the rolling member 7 and the axially elongated projection 4 are there in the same axial section, the present embodiment makes it possible to hold the rolling members 7, so that sliding function can be improved (stabilizing the sliding load). As a result, pleasant steering feeling can be obtained.

In the aforementioned second embodiment and the first through third variations, a further lower sliding load can be obtained by applying grease on the sliding surface and rolling surface. It may be possible that the curvature of the axially elongated projection 4 is made to be different from that of the axial groove 6 so that the axially elongated projection 4 and the axial groove 6 come into linear contact with each other. When the axially elongated projection 4 formed on the male shaft is formed on the female shaft, or the axial groove 6 formed on the female shaft is formed on the male shaft, the similar action and effect as the present embodiment can be obtained. It may be possible that the curvature of the axial groove 5 is made to be different from that of the rolling member 7 to come into point contact with each other.

### Other Related Matters

In all of the embodiments of the present invention, the solid male shaft may be replaced with a hollow shaft. Moreover, in all of the embodiments of the present invention, the followings may be said: The male shaft may be indiscerptible structure by plastically deforming the end portion thereof inward to prevent the male shaft from being extracted. Although the rolling member 7 is a spherical body (a ball) for an example, a roller may be used, it may be a heat-treated one, and it may be a polished one. The elastic member may be a leaf spring. The outer surface of the male shaft 1 may be processed with a resin coating including PTFE (polytetrafluoroethylene) or molybdenum disulfide. The male shaft 1 may be made of a solid or hollow steel material fabricated by cold pultrusion. The male shaft 1 may be made of an aluminum material fabricated by cold extrusion. The male shaft 1 may be made of a solid steel or aluminum material fabricated by cold forging. The female shaft 2 may be made of a hollow steel material fabricated by cold pultrusion molding. When the male shaft is fabricated by cold forging, the material is preferably carried out metallic soap treatment (bonderizing). The female shaft may be made of a hollow steel, and after carrying out metallic soap treatment (bonderizing), the material may be carried out reducing or extending process to the required diameter with forming groove portions by press forming. The female shaft 2 may be nitrided. The inner surface of the female shaft 2 may be treated with resin coating including PTFE (polytetrafluoroethylene) or molybdenum disulfide

In all of the embodiments of the present invention, it is preferable that the following numerical ranges are used:

Contact pressure of the rolling member is 1500 Mpa or less upon loading no torque.

Contact pressure of the rolling member is 2000 Mpa or less upon loading torque of 100 Nm.

Contact pressure of the axially elongated projection is 2000 Mpa or less upon loading torque of 100 Nm.

With comparing conventional products, the present invention is summarized as follows:

It is low cost.

It can obtain a stable, low sliding load.

It has no backlash.

It is superior to wear resistance

It is superior to heat resistance.

It can be made to be light weight.

It is a small mechanism.

It can cope with any using condition without changing design concept.

In Japanese Patent Application Laid-Open No. 2001-50293 and German Patent Application Laid-Open DE 3730393 A1, there is disclosed a mechanism that a plurality of rolling members are disposed in axial grooves formed on a male shaft and a female shaft and are preloaded by an elastic member. In comparison with this, the present invention, as described above, is far superior to the case where the whole rows are ball rolling mechanism or the case where a conventional spline-fitted mechanism is used.

In European Patent Application Laid-Open EP1078843A1, there is disclosed a mechanism that prevents backlash by being composed of needle rollers, a retainer thereof, and a regulator for removing backlash. However, the regulator is a simple sliding mechanism, so that the preload cannot be large. Accordingly, it becomes extremely difficult to prevent backlash or obtain high rigidity for long period.

On the contrary, as described above, the present invention is extremely superior in such manner that since a rolling mechanism is partially used and the way to prevent backlash is also different, the frictional resistance is low, so that the sliding load can be low, and the preload can be high, so that backlash can be prevented and high rigidity can be obtained for long period.

The present invention is not limited to the above-described embodiments and is possible to apply to various variations.

What is claimed is:

1. A telescopic shaft for vehicle steering that is assembled into a steering shaft for a vehicle and has a female shaft and a male shaft that are fitted relatively unrotatably but slidably, the telescopic shaft for vehicle steering comprising:
torque transmitting portions that are respectively disposed on an outer surface of the male shaft and on an inner surface of the female shaft and come in contact with each other for transmitting torque upon rotation; and
a preload portion composed of a rolling member that is disposed between the outer surface of the male shaft and the inner surface of the female shaft at a different position from a position where the torque transmitting portions are located and rolls when the male shaft and the female shaft relatively move in the axial direction and an elastic member that is disposed adjacent to the rolling member in the diametral direction and gives pressure upon the male shaft and the female shaft through the rolling member,
wherein when a gap in the torque transmitting portions is converted into a rotation angle A and a possible flexural amount of the elastic member in the preload portion is converted into a rotation angle B,
the rotation angle A should be less than the rotation angle B upon transmitting no torque.

2. The telescopic shaft for vehicle steering according to claim 1, wherein the rotation angle A at the torque transmitting portions is set from 0.01 degrees to 0.25 degrees.

3. The telescopic shaft for vehicle steering according to claim 1, wherein the torque transmitting portions are composed of a projection elongated in the axial direction and having a substantially arc sectional shape formed on the outer surface of the male shaft and a groove elongated in the axial direction and having a substantially arc sectional shape formed on the inner surface of the female shaft.

4. The telescopic shaft for vehicle steering according to claim 1, wherein the torque transmitting portions do not come in contact with each other continuously in the axial direction upon transmitting no torque.

5. The telescopic shaft for vehicle steering according to claim 1, wherein the torque transmitting portions are composed of a spline-fitting structure or a serration-fitting structure formed on the outer surface of the male shaft and the inner surface of the female shaft.

6. The telescopic shaft for vehicle steering according to claim 1, wherein the preload portion has a first axial groove disposed on the outer surface of the male shaft and a second axial groove disposed on the inner surface of the female shaft opposite to the first axial groove, and the rolling member and the elastic member are disposed between the first axial groove and the second axial groove.

7. The telescopic shaft for vehicle steering according to claim 1, wherein a plurality of preload portions are disposed between the male shaft and the female shaft, and the plurality of transmitting portions are disposed between adjacent preload portions.

8. The telescopic shaft for vehicle steering according to claim 7, wherein the preload portions are disposed in the circumferential direction with an interval of 180 degrees having the torque transmitting portions in-between.

9. The telescopic shaft for vehicle steering according to claim 7, wherein the preload portions are disposed in the circumferential direction with an interval of 120 degrees having the torque transmitting portions in-between.

10. The telescopic shaft for vehicle steering according to claim 9, wherein the torque transmitting portions are disposed at the center in the circumferential direction between the preload portions.

11. The telescopic shaft for vehicle steering according to claim 1, wherein the rolling member may include at least one spherical body.

12. The telescopic shaft for vehicle steering according to claim 1, wherein the elastic member is composed of a leaf spring.

13. The telescopic shaft for vehicle steering according to claim 1, wherein a solid lubricant film is formed on the outer surface of the male shaft or the inner surface of the female shaft.
